(19) United States
(12) Patent Application Publication
(10) Pub. No.: US 2003/0025637 A1
(43) Pub. Date: Feb. 6, 2003

(54) Miniaturized reverse-fed planar inverted F antenna

(75) Inventors: Greg S. Mendolia, Ellicott City, MD (US); John Dutton, Columbia, MD (US); William E. McKinzie III, Fulton, MD (US)

Correspondence Address: John G. Rauch, Brinks Hofer Gilson & Lione, P.O. Box 10395, Chicago, IL, 60610, US

(73) Assignee: e-tenna Corporation

(21) Appl. No.: 10/211,731

(22) Filed: Aug. 2, 2002

Related U.S. Application Data
(60) Provisional application No. 60/352,113, filed on Jan. 23, 2002.
(60) Provisional application No. 60/354,697, filed on Feb. 4, 2002.
(60) Provisional application No. 60/310,655, filed on Aug. 6, 2001.

(51) Int. Cl. H01Q 1/24

(52) U.S. Cl. 343/702

(57) ABSTRACT

In a planar inverted F antenna (PIFA), the feed and RF grounding connections are reversed yielding improved performance. Relative positioning of these connections is selected to tailor the characteristics of the antenna, such as resonant frequency and impedance bandwidth.

### CROSS REFERENCE TO RELATED APPLICATIONS

This application claims priority of U.S. provisional patent application serial No. 60/354,697, filed Feb. 4, 2002, and U.S. provisional patent application serial No. 60/352,113, filed Jan. 23, 2002, which applications are incorporated herein by reference in its entirety.

This application is related to U.S. Provisional Patent Application serial No. 60/310,655 filed Aug. 6, 2001 in the names of William E. McKinzie III, Greg S. Mendolia and Rodolfo E. Diaz and entitled “LOW FREQUENCY ENHANCED FREQUENCY SELECTIVE SURFACE TECHNOLOGY AND APPLICATIONS,” which application is incorporated herein by reference in its entirety.

### BACKGROUND

The present invention relates generally to antennas. More particularly, the present invention relates to a reverse-fed planar inverted F-type antenna (PIFA).

Each generation of communication devices is designed to be physically smaller than the previous generation. Small size is desirable to reduce physical size and weight and enhance user convenience. Many communication devices are designed and manufactured for consumer use. These include wireless devices such as radiotelephone handsets, handheld radios, personal digital assistants and lap top computers. Like all consumer products, these devices must be designed for low cost manufacturing and operation.

Manufacturers of wireless devices such as handsets, PDA's and laptops have very little room in their products given these extreme size and cost pressures. All of these devices require an antenna for wireless communication. These devices often need multiple antennas for operation at various frequency bands. It is desirable to incorporate the antenna within the package or case for reasons of esthetics, durability and size.

Such wireless devices typically pack a substantial amount of circuitry in a very small package. The circuitry may include a logic circuit board and an RF circuit board. The printed circuit board can be considered a radio frequency (RF) ground to the antenna, which is ideally contained in the case with the circuitry. Thus, the ideal antenna would be one that can be placed extremely close to such a ground plane and still operate efficiently without adverse effects such as frequency detuning, reduced bandwidth, or compromised efficiency. The antenna solution must also be cost effective for use in a consumer product.

A variety of other antennas having small profiles have been developed. These include Planar Inverted-F Antennas (PIFAs), types of shorted patches, and various derivatives, which may contain meander lines. To date, however, none of these antennas satisfy the present design goals, which specify efficient, compact, low profile antennas whose height is at most λ/60 above a ground plane, where A is the resonant frequency. There is a particular need for a 2.4 GHz antenna whose maximum height is at most 2.2 mm above a ground plane, and is thus well suited to devices requiring optimum performance in a compact volume, and operated according to the Bluetooth Standard, published by the Bluetooth Special Interest Group and IEEE Standard 802.11b, published by the Institute of Electrical and Electronic Engineers.

### BRIEF SUMMARY

By way of introduction only, the present invention provides in one embodiment a reverse-fed planar inverted F antenna. In another embodiment, the present invention provides a planar inverted F antenna (PIFA) including a radiating element, a feed, and a radio frequency (RF) short positioned between the feed and a radiating portion of the radiating element.

In yet another embodiment, the present invention provides an antenna including a ground plane and a radiating element disposed adjacent the ground plane and having a radiating portion and a feed end. A feed is electrically coupled with the feed end and a radio frequency short is between the ground plane and the radiating element at a ground point between the feed end and the radiating portion.

In yet another embodiment, the present invention provides a method for manufacturing an antenna. The method includes forming a radiating element on a dielectric layer, the dielectric layer including a conductive ground plane, the radiating element having a feed end and a radiating portion. The method further includes electrically contacting the feed end from a feed through the dielectric layer and electrically grounding the radiating element at a ground point between the feed end and the radiating portion.

The foregoing discussion of the preferred embodiments has been provided only by way of introduction. Nothing in this section should be taken as a limitation of the following claims, which define the scope of the invention.

### BRIEF DESCRIPTION OF THE DRAWINGS

FIG. 1 is a diagram showing a cross sectional view of a conventional planar inverted F antenna;

FIG. 2 is a diagram showing a cross sectional view of a reverse-fed planar inverted F antenna;

FIG. 3 is an isometric view of a meander line, reverse-fed planar inverted F antenna;

FIG. 4 illustrates simulation results for the meander line, reverse-fed planar inverted F antenna of FIG. 3;

FIG. 5 is a top view of a printed, coplanar reverse-fed planar inverted F antenna;

FIG. 6 is an isometric view of a second embodiment of a meander line, reverse-fed planar inverted F antenna; and

FIG. 7 illustrates simulation results for the meander line, reverse-fed planar inverted F antenna of FIG. 6;

FIG. 8 illustrates one embodiment of a simple, narrow, non-meander line, reverse-fed PIFA;

FIG. 9 illustrates another embodiment of a non-meander line reverse-fed PIFA in which the feed pin is located essentially at a corner of the patch; and

FIGS. 10-12 illustrate alternative embodiments of reverse-fed PIFAs.

### DETAILED DESCRIPTION OF THE PRESENTLY PREFERRED EMBODIMENTS

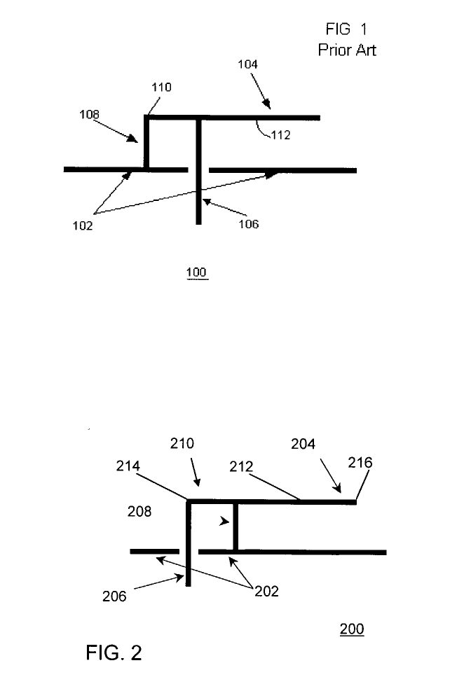

Referring now to the drawing, FIG. 1 is a diagram showing a cross sectional view of a conventional planar inverted-F antenna (PIFA) 100. The PIFA 100 includes a ground plane 102 and a radiating element 104. The conventional PIFA 100 is defined with a feed 106 positioned between a shorted end 110 and a radiating portion 112 of the radiating element 104. A radio frequency (RF) short 108 electrically shorts the shorted end 110 of the radiating element 104 to the ground plane.

The embodiment of the conventional PIFA 100 shows the basic elements of the device. The feed engages the radiating element at a feed point which is offset from the RF ground of the radiating element 104. However, in the conventional device, the feed point is positioned between the RF ground, which engages the radiating element at the shorted end 110 of the radiating element 104.

FIG. 2 shows a cross sectional view of a reverse-fed planar inverted F antenna (RFPIFA) 200. The RFPIFA includes a ground plane 202 and a radiating element 204 which is substantially parallel to the ground plane 202. The RFPIFA 200 further includes a feed 206 and an RF short 208. However, in the RFPIFA 200, the relative positions of the feed 206 and the RF short 208 have been changed.

The radiating element 204 includes a feed point 214 at a feed end 210 and a radiating portion 212, terminating in an open end 216. The feed 206 engages the feed end 210, which in the illustrated embodiments, is one end of the radiating element. In alternative embodiments, a stub may extend beyond the feed end 210 of the radiating element 204. The RF short 208 engages the radiating element 204 beyond the feed point 214. The effect is that the traditional feed point and ground point, as shown in FIG. 1, are reversed.

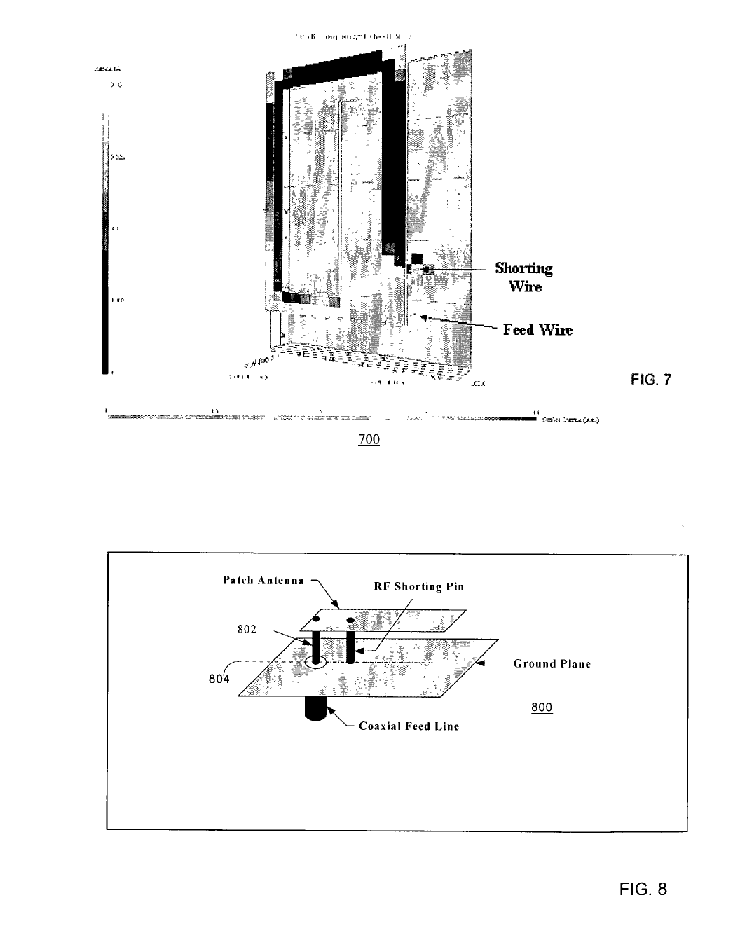

This arrangement is counter-intuitive, as the energy from the feed 206 now is presented with a short at the RF short 208 before the energy gets to the main radiating portion 212 of the radiating element 204. Intuition suggests that the energy fed to the RFPIFA 200 would substantially pass to the ground plane 202 through the RF short 208. However, as will be discussed below in conjunction with FIGS. 4 and 7, this is not the case.

The configuration of the RFPIFA 200 is fed from the end of the structure at feed end 210. There is no alternative path for the energy to flow other than across the RF short 208 in order to reach the radiating portion 212 of the radiating element 204. It has been discovered that configuring the feed 206 and the RF short 208 as shown in the drawing allows the antenna 200 to radiate very efficiently when placed very close to the ground plane 202. No other arrangement of RF short and feed and tested performs as well from the perspective of impedance matching and radiation efficiency.

The frequency of operation of the RFPIFA 200 is defined by at least two dimensions. The first and greatest influence on frequency is the length 220 of the radiating element 204, from the feed 206 to the open end 216. The length of the radiating element 204 is approximately one-quarter of a free space wavelength. The second is the position of the RF short 208 with respect to the feed 206. The position of the RF short 208 or ground return is also critical to optimize the match and bandwidth of the antenna 200 as seen from the feed 206. Based on experiments, the distance between the feed and RF short along the radiating element is approximately 1/20 to 1/5 of the total length of the radiating element 204. The exact position of the RF short is determined primarily by trial and error to optimize bandwidth, impedance match, and efficiency.

The RF short 208 is typically a pin or post, rather than a shorting wall. As such, this RF short contains a certain inductance associated with RF currents that flow through it. This inductive reactance will influence the impedance match, and this inductance is believed to be necessary for proper operation of the reverse-fed PIFA. Design rules for optimum inductance are not available at this time.

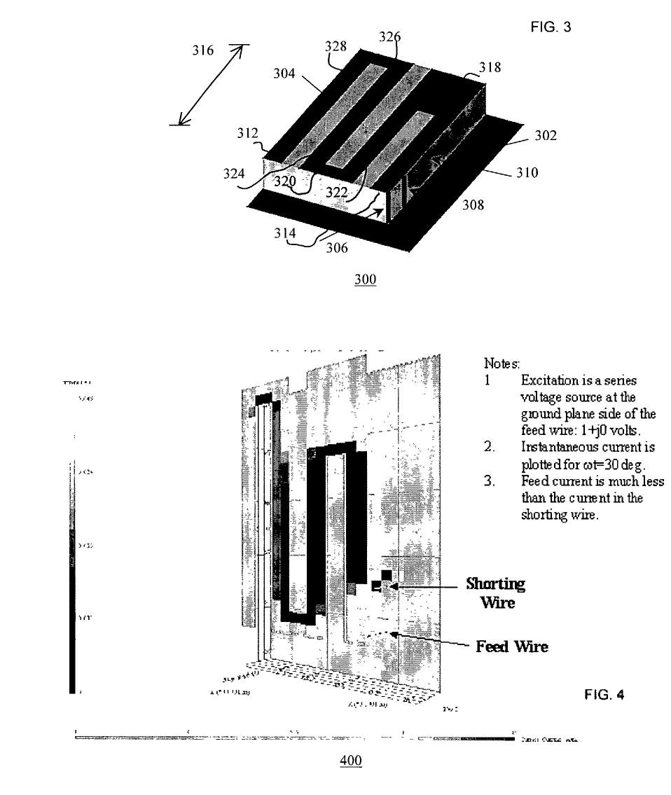

FIG. 3 illustrates an alternative embodiment of a RFPIFA 300. The RFPIFA 300 is configured as a meander line RFPIFA. The RFPIFA 300 includes a ground plane 302, a radiating element 304 which is substantially parallel to the ground plane 302, a feed 306 and an RF short 308. A dielectric layer, such as a foam core 310, is disposed between the ground plane 302 and the radiating element 304. The core may alternatively be FR4 or other suitable dielectric material.

In the embodiment of FIG. 3, the size of the RFPIFA 300 is reduced by meandering the radiating portion 312 of the radiating element 304. That is, a feed end 314 of the radiating element engages the feed 306. Beyond the feed 306, the radiating portion 312 of the radiating element 304 engages the RF short 308 and extends a distance 316. The radiating element 304 then turns at a turning portion 318 and forms a meander 322. The radiating element 304 then turns at a second turning portion 320 and forms a second meander 324. The radiating element 304 then turns at a third turning portion 326 and forms a third meander 328. The lengths and widths of the of the meanders 322, 324, 328 can be chosen, along with the number of meanders, to tailor the frequency of operation, the matching impedance and the bandwidth of the RFPIFA 300. The total length of the radiating sections is between one-quarter and one-half of a guide wavelength for the equivalent transmission line, which is also between one-quarter and one-half of a free-space wavelength assuming low dielectric constant substrates. Equivalent circuit models containing coupled microstriplines are an approximate means to estimate resonant frequency and impedance bandwidth. However, a full-wave electromagnetic simulator would be more accurate for a final analysis or design.

In one embodiment of the meander line RFPIFA 300, typical dimensions for the foam core 301 are 7.7×12×2 mm. Typical dimensions for the ground plane 302 are 10×14 mm. The meander line radiating element 304 is 1.1 mm wide in this example. The RF short 308 and the feed 306 are formed by vias through the foam core 310 and are spaced approximately 4 mm center to center.

The antenna 300 fabricated in this exemplary configuration showed excellent efficiency given its total volume. Antennas measuring 7.7 mm×12 mm and only 2.2 mm above the ground plane were seen to have efficiencies as high as 50% at 2.4 GHz, the frequency of operation as designed for the Bluetooth Standard and the IEEE 802.11 Standard. The antennas may be scaled to tailor operating characteristics to particular requirements. Similar results with antennas of different size have been seen at other frequency bands such as 800 MHZ for cellular radiotelephone applications.

The meander line RFPIFA 300 of FIG. 3 is a dual-band antenna. Simulations show that the antenna 300 radiates at two resonant frequencies of an approximate ratio 2:1. The dominant polarization at the low band is right hand circular polarization (RHCP), while the dominant polarization at the high band is left hand circular polarization (LHCP). However, the shape of the ground plane, and the nearby dielectric bodies, will greatly influence the far field polarization. Significant cross polarization radiation may be observed in real world installations.

The RFPIFA of FIGS. 2 and 3 not only has a counter-intuitive feed structure, but the currents on the antenna are equally counter-intuitive. One would expect the greatest magnitude of the RF current to flow between the feed and the RF short, with a lower surface current getting by the RF short and to the radiating element. However, simulations show that there are relatively low currents flowing between the feed and RF short, and the highest surface currents are between the RF-short and radiating element.

FIG. 4 illustrates simulation results for the meander line, reverse-fed planar inverted F antenna 300 of FIG. 3. FIG. 4 shows a full-wave simulation of the RFPIFA 300 at the low band resonance frequency of approximately 2.4 GHz.

Instantaneous wire currents are shown on the vertical scale and surface currents are shown on the horizontal scale. In this simulation, the excitation is a series voltage source at the ground plane side of the feed wire with voltage 1+j0 volts.

The instantaneous current is plotted for ωt=30 degrees. The feed current is much less than the current in the shorting wire.

The resulting radiation pattern from such a structure has been measured to be nearly omni-directional, radiating energy equally in all directions. The only direction with a null in the pattern is below the ground plane where the antenna is fed. Simulated patterns of the antenna in FIG. 3 also indicate a nearly omnidirectional pattern in the plane of the ground plane. However, this antenna is so small in area (0.064 λ×0.096 λ at 2.4 GHz) that its radiation pattern will be dictated by the size and shape of the ground plane to which it is attached. Performance of the RFPIFA is excellent regardless of the size of the ground plane it is mounted on. Unlike a standard PIFA such as the conventional PIFA of FIG. 1, the antenna of FIG. 3 does not need a large ground plane in order to operate efficiently. A typical ground plane as small as 30 mm by 30 mm works well.

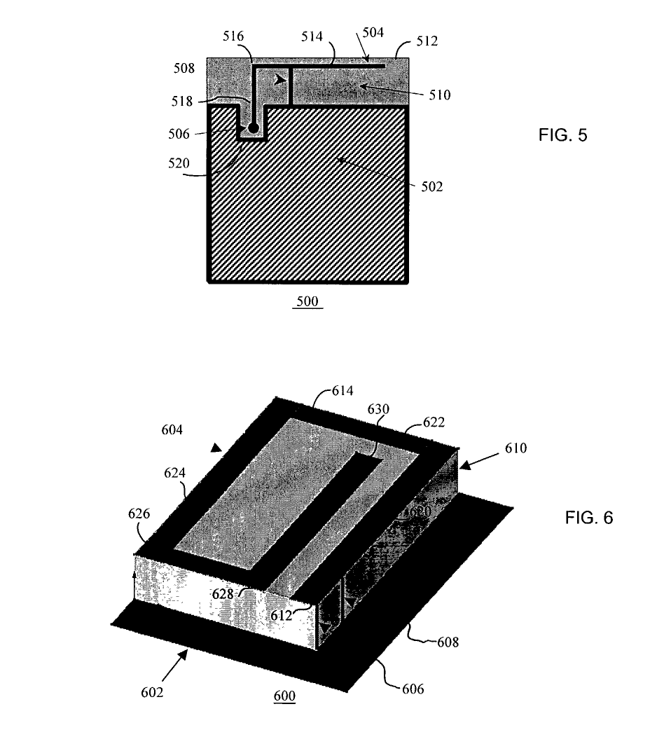

FIG. 5 is an alternative embodiment showing a top view of a printed, coplanar reverse-fed planar inverted F antenna (RFPIFA) 500. In FIG. 5, the antenna 500 is formed using conventional printed circuit board (PCB) technology. The antenna 500 includes a ground plane 502, a radiating element 504, a feed 506 and an RF short 508. The ground plane 502 is formed from metallization printed on a surface 512 of PCB material 510. In the same manner, the radiating element 504, the feed 506 and the RF short 508 are formed from metallization printed on the surface 512 of the PCB material 510.

The PCB material 510 may be any conventional printed circuit board and may include multiple layers of metallization. In one embodiment, the PCB material 510 is used to mount the circuits of a receiver or transceiver of a wireless product such as a Bluetooth radio module, radiotelephone, personal digital assistant or computer. The feed 506 in this embodiment is driven directly, with the circuit connections routed within the PCB material 510.

As in the other embodiments of FIGS. 2 and 3, the RF short 508 is in electrical contact with the ground plane 502. The RF short 508 is positioned between the feed and a radiating portion 514 of the radiating element. The RF short 508 is formed from shorting metallization extending from the ground metallization forming the ground plane 502 to the radiating element 504 between a feedpoint 516 and the radiating metallization. The feed 506 comprises feed metallization 518 between a feed port 520 and the feedpoint 516 of the radiating element. The feed port 520 may be electrically coupled with a transmitter or receiver circuit or diplexer or other circuitry of the wireless device including the antenna 500.

FIG. 6 is an isometric view of a second embodiment of a meander line, reverse-fed planar inverted F antenna 600 (RFPIFA). The RFPIFA 600 includes a ground plane 602, a radiating element 604, a feed pin 606 and an RF short 608. A foam core 610 is disposed on the ground plane 602. The radiating element 604 is disposed on the surface of the foam core 610. Any suitable materials and manufacturing techniques may be used for forming the RFPIFA 600. The feed in 606 and the RF short may be wires or posts inserted in the foam core 610 or may be vias formed therein. Or the RF feed 606 and RF short 608 may be vertical strips routed along the outside of the foam substrate, at the perimeter of the radiating element.

The radiating element 604 has a feed end 612 and a radiating portion 614. In accordance with the present invention, the RF short 608 connects the ground plane and the radiating element 614 at a ground point 616. The ground point 616 is positioned between the feed end 612 and the radiating portion 614 of the radiating element.

In one embodiment, the RFPIFA 600 has typical dimensions for the foam core 610 of 7.7×12×2 mm and the foam core 610 has εᵣ=1.2. Typical dimensions for the ground plane 602 are 10×14 mm. The spiraled radiating element is 1.1 mm wide. The RF short and the feed post 606 are spaced by approximately 4 mm on centers. The RFPIFA 600 is a dual band antenna with simulated resonances near 1.76 GHz and 4.68 GHz. The dominant polarization at the low band is right hand circular polarization (RHCP), while the dominant polarization at the high band is left hand circular polarization (LHCP).

In the embodiment of FIG. 6, the radiating element 604 is spiraled. That is, the metallization forming the radiating element 614 is shaped to turn inward toward a center. A first portion 620 meets a second portion 622 of the radiating element 604 at a substantially right angle. The second portion 622 meets a third portion 624 at a substantially right angle. The third portion 624 meets a fourth portion 626 at a substantially right angle. The fourth portion 626 meets a fifth portion 628 at a substantially right angle so that the fifth portion 628 lies substantially parallel to the first portion 620. An end 630 of the fifth portion is adjacent to but does not meet the second portion 622.

Spiraling the radiating element 604 has the effect of reducing the size or changing the relative dimensions of the RFPIFA 600. Operational characteristics such as resonance frequency, input impedance and bandwidth may be tailored as well by spiraling in a manner similar to that shown in FIG. 6. Reverse-fed PIFA antennas can also be made by winding the spiral clockwise from the feed, rather than counter-clockwise as illustrated in FIG. 6. In other words, mirror images of the meanderline and spiral geometries shown will enjoy the same benefits of reversing the conventional feed point and RF short.

The spiral pattern may be altered from that shown in FIG. 6 to meet particular design requirements. For example, the shapes in FIG. 6 are all rectilinear which may be most suitable for computer aided design and printing systems. Line width and spacing in such an embodiment are controlled by manufacturing design rules established to ensure reliable, low cost manufacturability. In other embodiments, non-right angle shapes may be allowed or curved shapes may be allowed by the design rules, and a spiraled radiating element such as the radiating element 604 may have any suitable shape required to meet the design goals for the antenna 600 and the wireless equipment incorporating the antenna 600.

FIG. 7 illustrates simulation results for the meandering spiral, reverse-fed planar inverted F antenna 600 of FIG. 6. FIG. 7 shows the surface and wire currents, which flow in the RFPIFA 600 at the low band resonance. The simulation shows that there are relatively low currents flowing between the feed 606 and the RF short 608. The highest surface currents are on the radiating element 604 lie between the RF short 608 and the open end at end 630. The simulation which produced the results of FIG. 7 used an excitation which is a series voltage source at the ground plane side of the feed wire, with voltage 1+j0 volts. The instantaneous current is plotted in FIG. 7 for ωt=70 degrees. The feed current is much less than the current in the wire for this phase angle.

From the foregoing, it can be seen that the present invention provides an improved antenna and method for producing an efficient, compact low profile antenna. The height of antenna embodiments described herein is less than λ/60 above a ground plane, where/is the free space wavelength at the resonant frequency.

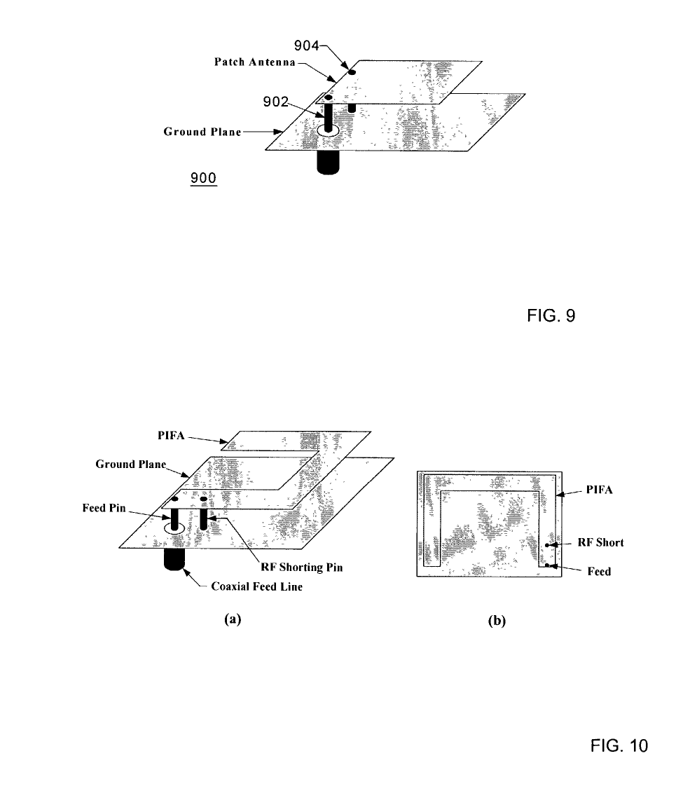

Given that the definition of a reverse-fed PIFA is simply a PIFA in which the positions of the feed pin and shorting pin are reversed relative to conventional practice, many embodiments are possible. Some of the simplest embodiments are illustrated in FIGS. 8 and 9.

In FIG. 8, the PIFA 800 is a long thin patch, excited by a feed pin 802 located at one extremity along the longitudinal centerline 804. The RF shorting pin or post may also be located on or near this centerline, typically separated from the feed pin by 1/10 to 1/5 the overall length of the patch. The lowest, or fundamental, resonant frequency is approximately defined where the patch height plus length is one quarter of a free space wavelength.

FIG. 9 shows another embodiment of a PIFA 900 where the PIFA 900 is a relatively wide patch. It is excited in or near one corner by a coaxial feed pin 902. An RF shorting pin 904 is located along one of the sides of the square patch. The resonant frequency may be estimated as that frequency where the patch length plus patch width is one-quarter of a free space wavelength. Again, the position of the shorting pin 904 has a dominant impact on input impedance, and a relatively minor impact on resonant frequency. The feed pin 902 and shorting pin 904 may be realized as printed strips, plated through holes, screws, rivets, conductive straps, or any vertical conductive structure.

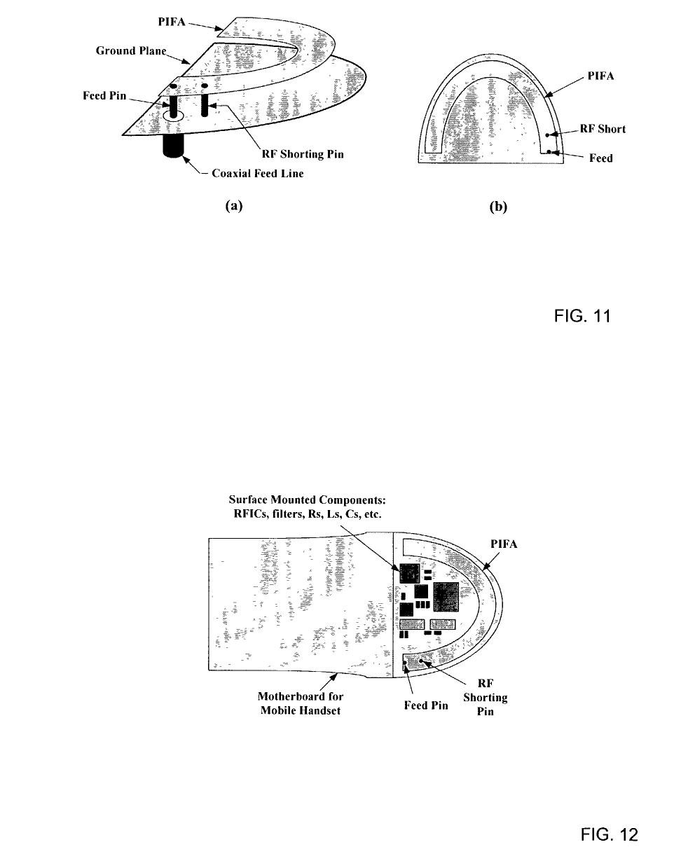

It has been discovered that optimum performance is achieved when the ground plane is truncated such that the radiating element is located near the edge of the ground plane. Examples of this feature are shown in FIGS. 10 and 11, which illustrate U-shaped and semi-circular PIFA footprints. This has been observed for both spiral and meanderline PIFAs. Radiation efficiency measurements have shown as much as a doubling of antenna efficiency relative to mounting the PIFA near the center of a one k square ground plane.

Reverse-fed PIFAs, which meander to form a partial turn, as shown in FIGS. 10 and 11, have an additional advantage of freeing the center of the ground plane for integration of other components in a wireless product. An example is shown in FIG. 12 where RF front end components such as transmitter and receiver circuits are installed on the PIFA's ground plane, but interior to the perimeter of the semi-circular PIFA, all of which fit into the top end of a mobile phone. The semicircular printed patch may be supported on a semicircular dielectric substrate. This form factor is very attractive for portable wireless devices where available real estate to surface mount components is a premium.

Antennas using conventional technologies and topologies such as a PIFA have fundamental performance limitations and trade-offs. For a given volume, an antenna is limited to a fundamental gain-bandwidth product. For a given application, bandwidth is dictated by specifications, leaving gain or efficiency to be traded against each other. But this efficiency is a theoretical limit, and the realized gain is degraded by multiple effects such as conductor losses, mismatch at the antenna input, proximity to ground plane, and absorption by lossy material. High efficiency is often achieved with high Q materials such as ceramic dielectrics, but this often yields a bandwidth that is too narrow.

One advantage of the embodiments disclosed herein is the creation of an antenna with above-average performance when placed very close to a ground plane. This low-profile, highly efficient antenna is also very low cost, using no exotic materials or costly dielectrics.

These characteristics are ideal for applications in wireless products such as handsets, PDAs and laptops that are wirelessly connected to a Local Area Network (LAN) or Personal Area Network. (PAN) This technology can be scaled to various frequencies such as 800 MHz (cellular), 900 MHz (GSM), 1575 MHz (GPS) 1800 MHz (GSM), 1900 MHz (PCS), 2400 MHz (Bluetooth and 802.11), 5200 MHz (802.11) and higher frequencies.

In fact, yet another advantage of the disclosed embodiments is that some of these embodiments display a dual band response. These resonances are not harmonically related, and can be designed to specific frequencies by proper selection of radiating element length, RF short position, number of meander turns, line width, length-to-width ratio, and a variety of other design factors.

While a particular embodiment of the present invention has been shown and described, modifications may be made. It is therefore intended in the appended claims to cover such changes and modifications, which follow in the true spirit and scope of the invention.

1. A planar inverted F antenna (PIFA) comprising:
a radiating element;
a feed coupled to one extremity of the radiating element; and
a radio frequency (RF) short positioned between the feed and a radiating portion of the radiating element.

2. The PIFA of claim 1 further comprising:
a ground plane electrically coupled with the RF short and positioned substantially parallel to the radiating element.

3. The PIFA of claim 2 further comprising:
one or more dielectric layers disposed between the ground plane and the radiating element.

4. The PIFA of claim 2 wherein the radiating element is positioned at a height less than less than λ/20 from the ground plane, λ being the free-space wavelength for the resonant frequency of the PIFA.

5. The PIFA of claim 2 wherein the ground plane defines an aperture for access to the feed.

6. The PIFA of claim 1 wherein the radiating element has a length chosen based on a desired frequency of operation of the PIFA.

7. The PIFA of claim 1 wherein the RF short has a position relative to position of the feed, such that the RF short position is chosen based on a desired frequency of operation and the desired input impedance of the PIFA.

8. The PIFA of claim 1 wherein the radiating element is meandered.

9. The PIFA of claim 1 wherein the radiating element is spiraled.

10. The PIFA of claim 1 further comprising:
a printed circuit board; and
ground metallization on a first side of the printed circuit board forming a ground plane for the PIFA.

11. The PIFA of claim 10 wherein the radiating element comprises radiating metallization on the first side of the printed circuit board spaced from the ground metallization.

12. The PIFA of claim 11 wherein the feed comprises a conductive trace between a feed port and a feedpoint at one end of the radiating element.

13 The PIFA of claim 10 wherein the radiating element comprises radiating metallization on a second side of the printed circuit board spaced opposite from the ground metallization.

14. The PIFA of claim 13 wherein the RF short comprises a conductive trace extending from the ground metallization to the radiating element between the feedpoint and an open end of the radiating metallization.

15. An antenna comprising:
a ground plane;
a radiating element disposed adjacent the ground plane and having a radiating portion and a feed end;
a feed port electrically coupled with the feed end; and
a radio frequency short between the ground plane and the radiating element at a ground point between the feed end and the radiating portion.

16. The antenna of claim 15 wherein the radiating portion is meandered.

17. The antenna of claim 15 wherein the radiating portion is spiraled.

18. The antenna of claim 16 wherein the radiating portion is formed in a U-shape.

19. The antenna of claim 15 wherein the radiating portion is formed in an arc.

20. The antenna of claim 15 further comprising one or more dielectric layers between the radiating element and the ground plane.

21. The antenna of claim 20 wherein the one or more dielectric layers comprise a foam core.

22. A method for manufacturing an antenna, the method comprising:
forming a radiating element on one or more dielectric layers, the dielectric layers located between a conductive ground plane, and the radiating element having a feed extremity and a radiating portion;
electrically contacting the feed end from a feed pin through the dielectric layers; and
electrically grounding the radiating element at a grounding point located essentially between the feed end and the radiating portion.
